(19) United States
(12) Patent Application Publication
(10) Pub. No.: US 2005/0144087 A1
(43) Pub. Date: Jun. 30, 2005

(54) Disparate sales system integration and method

(76) Inventors: Jane Huang, Mankato, MN (US); Mark E. Peterson, Mankato, MN (US)

Correspondence Address: SHUMAKER & SIEFFERT, P. A., 8425 SEASONS PARKWAY, SUITE 105, ST. PAUL, MN, 55125, US

(21) Appl. No.: 10/888,525

(22) Filed: Jul. 9, 2004

Related U.S. Application Data
(60) Provisional application No. 60/485,764, filed on Jul. 9, 2003.

(51) Int. Cl. G06F 17/60

(52) U.S. Cl. 705/26; 705/27

(57) ABSTRACT

A software system may be used to transfer sales data between two software modules having different data formats and data organizations. Entity objects containing executable code specified using metadata from a metadata database is used to process XML data representing data being transferred between the systems. These entity objects use metadata from the metadata database to define how data format transformations are to occur.

This application claims the benefit of U.S. Provisional Application, entitled SALES PERFORMER 2004 ERP INTEGRATION, Ser. No. 60/485,764, filed Jul. 9, 2003, the entire content of which is incorporated herein by reference.

### TECHNICAL FIELD

The invention relates to product configuration and sales systems, and more specifically to systems to integrate various sales systems with enterprise resource planning systems.

### BACKGROUND

Software based product configuration and sales systems provide sellers an automated tool to assist in the configuration of custom products from a large set of components, options and features that are available for the customizable products. Product configuration tools typically utilize product data constructed from a hierarchical set of product-option-attributes listings as well as a set of configuration rules that define how products may be customized. The configuration rules typically constrain a set of available product options given selected options already specified in defining a product.

Enterprise resource planning systems are used by sellers to integrate many of the business processing functions into a single enterprise-wide processing system. This enterprise-wide processing system typically includes accounting, inventory, contact management, order processing, billing and similar business processing functions.

Typically, product sales systems that perform product configuration functioning are separate from the enterprise resource planning systems with different data management, data organization and product definition and ordering processes. Sellers typically use the product sales systems to work with customers when defining configurable products for sale to the customer. Once the sale is complete, the sales and ordering data, including customer identity and billing information, are re-entered into the enterprise planning system in order to permit the seller to track the completion of the sale and related billing activities. This re-entering of data is a time consuming and error-prone process.

Custom processing systems have been developed to integrate these two disparate processing systems such that ordering and customer information obtained and entered into the product sales system may be passed electronically to the enterprise resource planning system. These integration efforts are typically custom development activities that exactly match the data requirements and data formats for the two systems. Each time a change is made to either system, significant development of software is needed to keep these two disparate processing systems communicating between each other. Additionally, because this integration effort is tied to the exact implementations of the two processing systems, a seller may not easily replace either processing system without completely reproducing the integration processing software. These additional and repetitive development activities limit sellers ability to move to new and different processing systems for both product sales systems and enterprise resource planning systems.

### SUMMARY

In general, the invention is directed to an integrated sales and enterprise resource planning processing system for sellers of products to define custom configuration of products to satisfy customer needs. The integrated sales and enterprise resource planning processing system may be used to transfer sales data between two software modules having different data formats and data organizations. Entity objects containing executable code specified using metadata from a metadata database are used to process XML data representing data being transferred between the systems. These entity objects use metadata from the metadata database to define how data format transformations are to occur.

In one embodiment, the invention is directed to method for transferring data between two disparate processing systems. The method generates text data representation of a set of data being transferred from a first processing system to a second processing system; processes the data representation of data into a transformed text data representation referring to a common data format defined within a metadata database; initiates a data transfer request; and processes the transformed data representation using an entity object to transfer the set of data to the second processing system.

In another embodiment, the invention is directed to a computer-readable medium containing instructions. The instructions cause a programmable processor to generate text data representation of a set of data being transferred from a first processing system to a second processing system; process the data representation of data into transformed text data representation referring to a common data format defined within a metadata database; initiate a data transfer request; process the transformed data representation using an entity object to transfer the set of data to the second processing system; generate a response representation of data corresponding to output from the entity object processing of the transformed data representation; and process the response representation of data within the first processing system to update the first processing system regarding transfer of the set of data.

In another embodiment, the invention is directed to a method for creating a set of software components for data transfer between a selling application module and a enterprise resource planning module. The method generates XML data associated with a data fields of a selling application module used to transfer a set of data from the selling application module to an enterprise resource planning module; creates new schema data files within a metadata database specifying one or more sets of data to be transferred between the selling application module and the enterprise resource planning module; creates a plurality of entity objects specified with metadata stored within the metadata database to map data within the plurality of entity objects to data fields in the metadata database; and creates an instance of a entity object handler to initiate creation of instances of one of the plurality of entity objects when the set of data is transferred between the selling application module and the enterprise resource planning module.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an integrated sales and enterprise resource planning processing system according to an embodiment of the present invention.

FIG. 2 is a block diagram illustrating a general programmable processing system for use in an integrated sales and enterprise resource planning processing system in accordance with an example embodiment of the present invention.

FIG. 3 is a block diagram illustrating a detailed processing system for the integrated sales and enterprise resource planning processing system of FIG. 1 according to an embodiment of the present invention.

FIG. 4 is a block diagram illustrating an example entity within metadata database in accordance with an example embodiment of the present invention.

FIG. 5 is a flowchart describing integrating a custom connector module with an integrated sales and enterprise resource planning system 100.

FIG. 6 is a flowchart illustrating an example submit order operation from a selling application module to an enterprise resource planning module according to the present invention.

### DETAILED DESCRIPTION

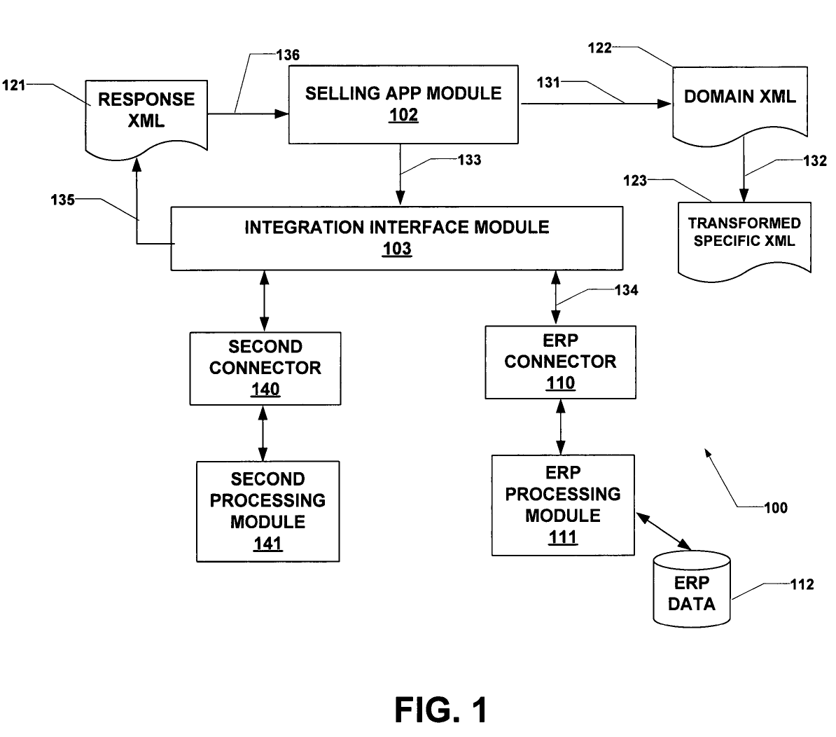

FIG. 1 is a block diagram illustrating an integrated sales and enterprise resource planning processing system according to an embodiment of the present invention. The integrated sales and enterprise resource planning system 100 provides an integration framework that permits product sales and customer information generated and used within an integrated sales application module 102 to be passed to and from an enterprise resource planning (ERP) processing module 111. Integrated sales application module 102 communicates with an integration interface module 103 to transform its internal data into a common format for use in communicating with ERP processing module 111. Similarly, ERP processing module 111 communicates with this integration interface module 103 through an ERP connector module 110. ERP connector module 110 translates ERP processing module internal data to the common data format used within integration interface module 103. In one embodiment, the common data format is specified in Extensible Markup Language (XML) as defined by the www.w3c.org standards organization. XML language permits data formatted in various arrangements to communicate with each other using an XML schema and language representation of the data.

Integrated selling application module 102 may communicate with a second processing module 141 through its own second connector module 140 in an identical manner. Because schemas and their respective specification of data organization may be specified in XML, any connector module needed to interface a processing system to the integrated sales and enterprise resource planning system 100 may be accomplished.

An example of an integrated sales processing system may be found within a commonly assigned U.S. Pat. No. 6,067,525, entitled “INTEGRATED COMPUTERIZED SALES FORCE AUTOMATION SYSTEM.” An example embodiment of product data manager module may be found in commonly assigned U.S. Pat. No. 6,141,658 entitled “COMPUTER SYSTEM AND METHOD FOR MANAGING SALES INFORMATION,” and U.S. Pat. No. 6,438,547 entitled “COMPUTER READABLE DATA PRODUCT FOR MANAGING SALES INFORMATION.” An integrated sales processing system may include and utilize selling application modules and runtime configuration modules as part of its functionality. Examples of processing systems that include selling application module and run-time configuration module are described in commonly assigned U.S. Pat. No. 5,493,490, entitled “ELECTRONIC PROPOSAL PREPARATION SYSTEM FOR SELLING VEHICLES;” U.S. Pat. No. 5,615,342, entitled “ELECTRONIC PROPOSAL PREPARATION SYSTEM;” U.S. Pat. No. 5,625,776, entitled “ELECTRONIC PROPOSAL PREPARATION SYSTEM FOR SELLING COMPUTER EQUIPMENT AND COPY MACHINES;” U.S. Pat. No. 5,283,865, entitled “COMPUTER ASSISTED PARTS SALES SYSTEM;” and U.S. Pat. No. 5,283,865, entitled “COMPUTER ASSISTED PARTS SALES METHOD,” All of these U.S. patents are hereby incorporated by reference herein in their entirety.

When integrated selling application module 102 desires to transmit data, such as an order for configured products prepared at the request of a particular customer, integrated selling application module 102 generates XML data 131 that contains relevant information regarding the configured product, the customer identity and billing information, the price of the products, requested delivery information and other similar sales data. The XML data 131 is stored within a domain XML file 122. The domain XML file typically references the sales data within data formats and field references used within integrated sales application module 102.

The domain XML file 122 is further processed into transformed XML data 132 which is stored within a transformed specific XML file 123. This transformed XML data references the data in a common format understood within integrated interface module 103 and ERP connector module 110.

The transformed specific XML file contains order data for submission to the ERP processing module 111. Integrated selling application module 102 transmits the transformed specific XML data 123 to integrated interface module 103 in a call interface operation 133. This call interface operation 133 creates a software class object within integrated interface module 103 that is then populated with sales data references within the transformed specific XML data 123. The created class object is then passed to ERP connector module 110 that processes the create order operation specified in the class object to interact with ERP processing module 111 to insert product order information associated with a sale of configured products to a particular customer into the ERP processing module's data 112 for further use by the ERP processing module.

When the transformed specific XML data 123 is processed within ERP connector module 110, a response message indicating the status of the create sales operation is generated. This message is passed to integration interface module 103 and is used to generate response XML data 135 that is stored within response XML data file 121. The response XML data file 121 is returned to integrated sales application module 102 for further processing 136 as is needed to update the sales application module.

Integrated selling application module 102 may request data, such as customer address and contact information that may be stored with ERP processing module data 112 using a similar process. A request for data may be transmitted as a data request operation 133 transmitted to integration interface module 103. The transformed specific XML data contains information to identify the customer corresponding to the contact information requested. ERP connector module 110 processes the request as before to obtain the contact information from ERP processing module 111 as stored in its data store 112.

Response XML file 121 returned from the completion of the data request 133 contains the customer contact information requested. This contact data may be then used within integrated selling application module 102 as needed.

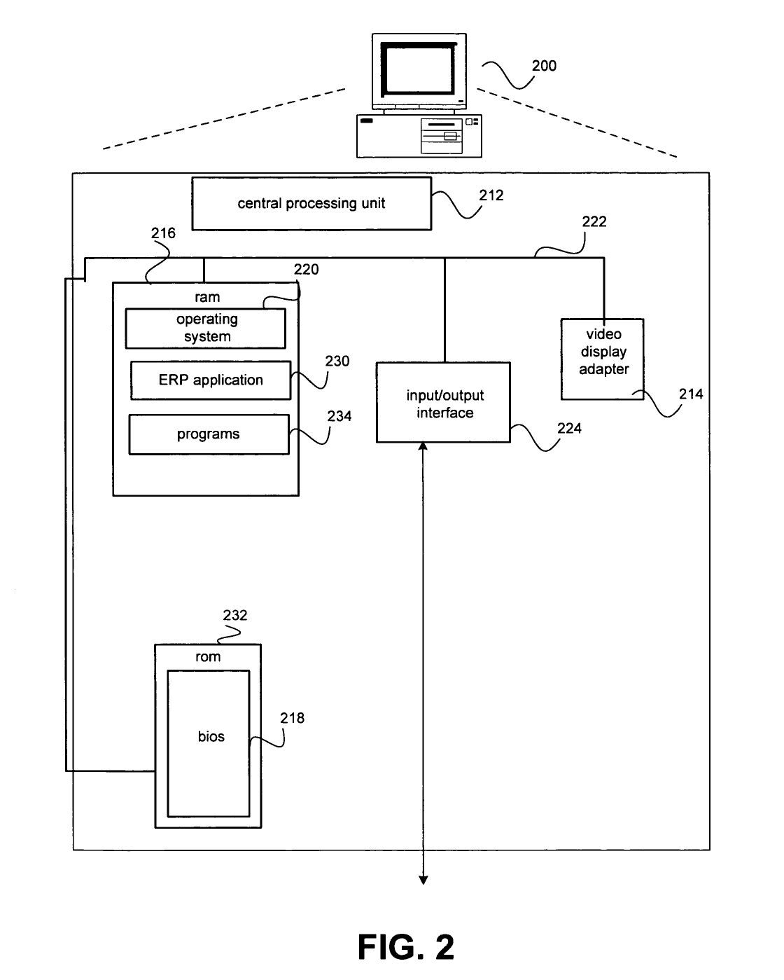

FIG. 2 is a block diagram illustrating a general programmable processing system for use in an integrated sales and enterprise resource planning processing system in accordance with an example embodiment of the present invention. In an exemplary embodiment of a processing system 200, computing system 200 is operative to provide an integrated sales and enterprise resource planning processing system. Those of ordinary skill in the art will appreciate that the an integrated sales and enterprise resource planning processing system 200 may include many more components than those shown with reference to a computing system 200 shown in FIG. 2. However, the components shown are sufficient to disclose an illustrative embodiment for practicing the present invention.

As shown in FIG. 2, an integrated sales and enterprise resource planning processing system 200 includes processing unit 212, video display adapter 214, and a mass memory, all connected via bus 222. The mass memory generally includes RAM 216, ROM 232, and may include one or more mass storage devices, such as a removable memory device such as a Compact Flash, Smart Media, or Secure Digital memory card. The memory devices may store an operating system 220 for controlling the operation of ERP processing system 200. It will be appreciated that this component may comprise a general purpose server operating system as is known to those of ordinary skill in the art, such as UNIX, MAC OS™, LINUX™, or Microsoft WINDOWS®. Basic input/output system (“BIOS”) 218 is also provided for controlling the low-level operation of processing system 206.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. The mass memory also stores program code and data for providing a software development training system. More specifically, the mass memory stores applications including ERP connector processing program 230, and other programs 234, and similar analysis applications 234 as may be needed. The ERP connector processing program 230 includes computer executable instructions which are executed to perform the logic described herein.

The integrated sales and enterprise resource planning processing system 200 also comprises input/output interface 224 for communicating with external devices, such as a touch screen and similar input devices, or other input devices not shown in FIG. 2. Likewise, the catalog management processing system 200 may further comprise additional mass storage facilities also not shown should additional data storage be needed.

One skilled in the art will recognize that the processing system illustrated within FIG. 2 may represent a set of processing components typically found within back-office dedicated processing system. Of course, other processing systems including general purpose computing systems containing additional peripherals and user interface devices may also be used to implement the programmable processing according to various embodiments of the present invention without deviating from the spirit and scope of the present invention as recited within the attached claims. For example, a dedicated processing system may consist of a digital signal processor (DSP) for performing the required floating-point math, various internal memory types including FLASH, ROM, RAM, and FPGA, some minimal external memory for the ERP processing system, and a user interface and display driver chip to run the switches and custom LCD display. A proprietary embedded operating system is and a specifically written application for implementing the ERP processing program may be included.

FIG. 2 illustrates an example of a suitable operating environment in which the invention may be implemented. The operating environment is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The invention may also be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Processing devices typically includes at least some form of computer readable media. Computer readable media can be any available media that can be accessed by these devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by processing devices.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

Additionally, the embodiments described herein are implemented as logical operations performed by a programmable processing device. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

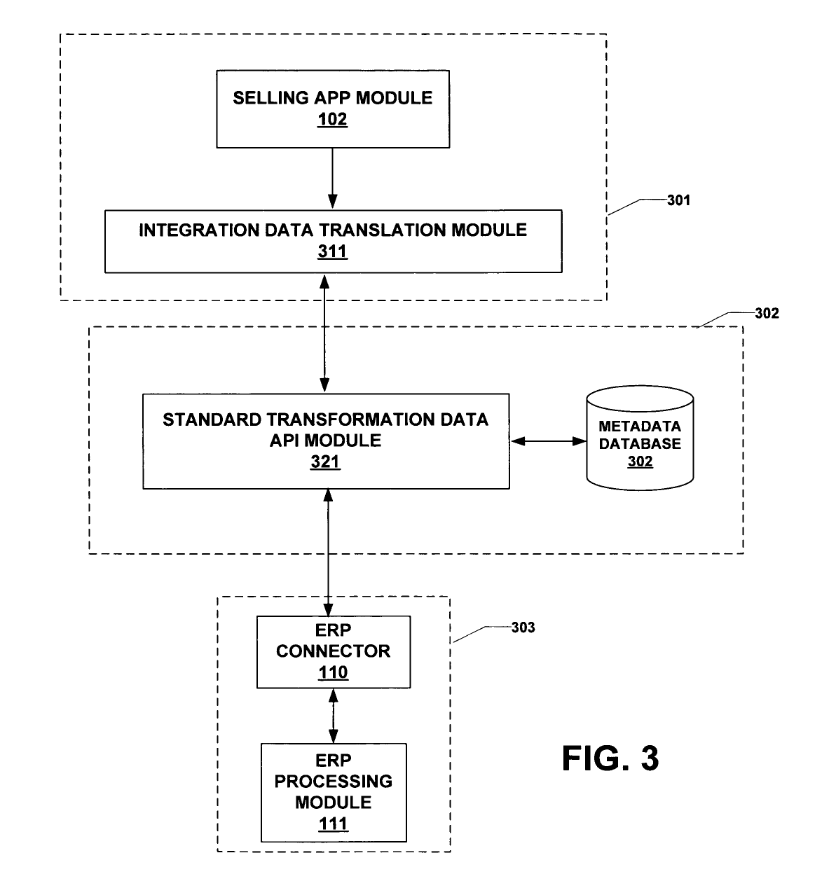

FIG. 3 is a block diagram illustrating a detailed processing system for the integrated sales and enterprise resource planning processing system of FIG. 1 according to an embodiment of the present invention. Integrated sales and enterprise resource planning system 100 may be described as have three separate layers of software interacting as integrated selling application module 102 communicates with ERP processing module 111. First a client presentation layer 301 includes integrated selling module 102 and integrated data translation module 311. A second layer, business layer 302 includes standard transformation API module 321 and metadata database 322. Finally, an integration layer 303 includes ERP connector module 110 and ERP processing module 111.

Integrated selling application module 102 configures customized products matching requirements of customers and is used by sellers to generated orders for configurable products. Integration data translation module 311 accepts sales data from integrated selling application module 102 to generate an XML data file representing an order for products that is sent through system 100 to ERP processing module 111. Integration data translation module 311 also generates requests for data to be retrieved from ERP processing module 111 through a similar processing request mechanism. These two processing modules together provide a client process, in this embodiment the integrated selling application module 102, a processing mechanism to generate requests to send data to and retrieve data from ERP processing module 111.

In the business layer, a standard transformation data API module 321 operates with a metadata database 322 to accept transformed XML data, stored in an XML file 123, that is placed into an entity object for processing within ERP connector module 110. In an exemplary embodiment, the entity objects are java class objects that are based upon XML schema documents obtained from metadata database 322. Each set of data transferred between integrated selling application object 102 and ERP processing module 111 is transmitted in the form of a data document. Each data document corresponds to various sales activities such as sales order, customer create request, and a sales order output. Every sales activity in which data is to be transmitted between integrated selling application object 102 and ERP processing module 111 uses its own data document. Every data document corresponds to a schema XML document stored within metadata database 322. When a new sales activity is to be added as a set of data that may be transmitted between integrated selling application object 102 and ERP processing module 111, a new schema XML document corresponding to the data transferred is needed within the metadata database 322.

The Schema XML documents in metadata database 302 store mapping information for data fields used within integrated selling application object 102 and ERP processing module 111 to permit the data in question to be transferred between the disparate processing systems. As such, metadata database 302 provided a customizable interface that may be adapted to support any number of different interfaces between selling applications and enterprise wide processing systems.

The integration transformation data API module 321 uses the documents from the metadata database and the transformed XML file 123 to transform data within XML file 123 into data useable within ERP connector module 110. Integration transformation data API module 321 uses XSL data from the metadata database to complete this data transformation.

XSL data corresponds to an Extensible Stylesheet Language Family, XSL is a family of recommendations for defining XML document transformation and presentation. XSL data consists of three parts: XSL transformations (XSLT) a language for transforming XML; XML Path Language, an expression language used by XSLT to access or refer to parts of an XML document; and XSL Formatting objects (XSL-FO), and XML vocabulary for specifying formatting schematics. An XSLT stylesheet specifies the presentation of a class of XML documents by describing how an instance of the class is transformed into an XML document that uses a formatting vocabulary, such as XSL-FO.

Java entity objects are then created using the XML data file 123 and the above metadata database 322 data. Each class and field of data within the schema XML documents are exchanged within the java entity object to populate data that is to be transmitted between integrated selling application object 102 and ERP processing module 111. Once the data is within the java entity object, the object is executed within ERP connector module 110 to transmit data to and from ERP processing module 111.

Integration layer 303 contains the ERP connector module 110 and the ERP processing module that provides the back-office processing systems for the seller. The integration layer 303 also interfaces the back-office processing systems with the business layer 302.

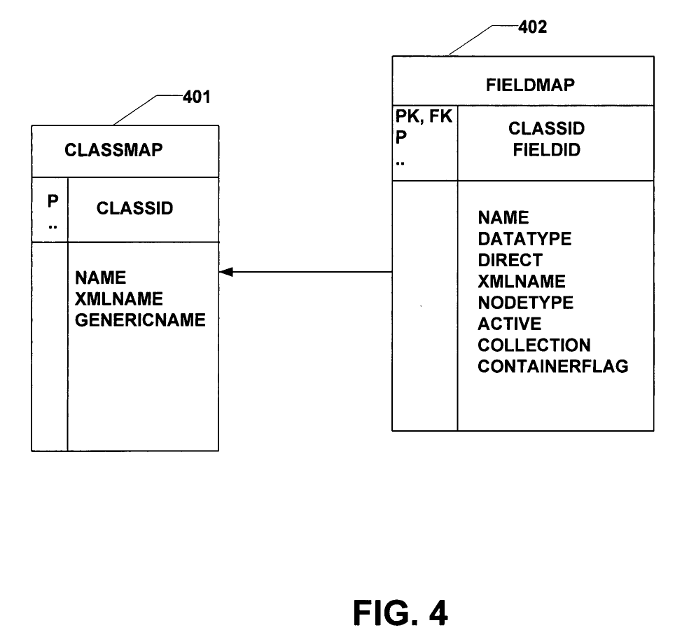

FIG. 4 is a block diagram illustrating an example entity within metadata database in accordance with an example embodiment of the present invention. In this example, a classmap 401 is shown having a fieldmap 402 corresponding to the various fields within the class. Data within metadata database 322 is stored within relational tables of a relational database. Table 1 describes the various mapping of different entities in the relational database. Each entity corresponds to a separate Java class and corresponding XML schema document. For example, Customer Input, Sales Order Create, and Sales Order Update possess separate entities.

TABLE 1
CLASSMAP ENTRIES

| Column Name | Data type - size | Null | Comments |
|---|---|---|---|
| CLASSID | INT - 4 | No | Primary key |
| NAME | VARCHAR - 255 | No | Name of the entity as defined in the |
| | | | class name (with the package name and |
| | | | specific to the ERP processing module |
| XMLNAME | VARCHAR - 50 | No | The name of the class as it should |
| | | | appear in XML. This name will be the |
| | | | name of the element on the XML file |
| | | | for the class. This name is used so that |
| | | | the output XML will have a simple |
| | | | name like ‘Customer’ instead of a |
| | | | complete package name like |
| | | | ‘com.erp.iss.ErpCustomer” |
| GENERICNAME | VARCHAR - 50 | No | The general name of the class; this |
| | | | name is another unique value to |
| | | | identify the class. This name is used by |
| | | | the connector module to load the mapping |
| | | | of the class |

Table 2 describes mappings of attributes of entities. Each attribute corresponds to an attribute of the parent (entity) Java class. For example, a Customer Input Entity possesses a set of attributes including Customer Name, Company Code, Address, etc. A separate FIELDMAP 402 exists for each the attributes of an entity.

TABLE 2
FIELD MAP

| Column Name | Data Type - Size | Null | Comments |
|---|---|---|---|
| CLASSID | INT - 4 | No | Part of Primary key; referred to as |
| | | | CLASSID in ClassMap table |
| FIELDID | INT - 4 | No | Part of Primary key; sequence number |
| | | | for fields of entity. This is an integer |
| | | | value used as part of the primary key to |
| | | | uniquely identify the field |
| NAME | VARCHAR - 30 | No | Name of the field as appearing in the |
| | | | Java class |
| DATATYPE | VARCHAR - 255 | No | Data type of the field as declared in the |
| | | | Java class |
| DIRECT | VARCHAR - 5 | No | A Boolean flag to indicate whether the |
| | | | field is access directly or through a |
| | | | set/get method. |
| XMLNAME | VARCHAR - 25 | No | Name of the field as it will appear in |
| | | | the XML document |
| NODETYPE | VARCHAR - 20 | No | Specifies how this field node should |
| | | | appear in the XML document ie. |
| | | | element, attribute, etc |
| ACTIVE | CHAR - 1 | No | Indicates whether this field mapping is |
| | | | active for this implementation “Y/N” |
| COLLECTION | VARCHAR - 30 | No | Specifies the collection type: array, |
| | | | vector or null |
| CONTAINERFLAG | VARCHAR - 1 | No | Indicates whether this field refers to |
| | | | another class or not |

All entity objects are defined as classes having corresponding CLASSMAP tables 401. Every entity within each class correspond to a separate FIELDMAP 402. In the exemplary embodiment, the set of tasks or data transfer requests that are supported are described in detail in Table 3. Other tasks may be added using the above data structures.

TABLE 3
TASK LIST OF DATA TRANSFER REQUESTS

| | | Function - Operation |
|---|---|---|
| Task ID | Task Name | Performed |
| 1 | CUSTOMER_FETCH | Fetch the details about |
| | | customer from ERP |
| | | processing module |
| 2 | CUSTOMER_CREATE | Create a Customer(s) in ERP |
| | | processing module |
| 3 | CSUTOMER_UPDATE | Update Customer(s) in ERP |
| | | processing module |
| 4 | MATERIAL_FETCH | Fetch FERT materials from |
| | | ERP processing module |
| 5 | CONFIGURABLE_MATERIAL_FETCH | Fetch Configurable materials |
| | | from ERP processing module |
| 6 | VARIENT_CONDITION_FETCH | Fetch price conditions that |
| | | are directly assigned to |
| | | characteristic values from |
| | | ERP processing module |
| 7 | SALES_ORDER_CREATE | Create a Sales Order |
| 8 | QUOTATION_CREATE | Create a Quote |
| 9 | CONDITION_RECORDS_FETCH | Fetch Pricing conditions |
| | | from ERP processing module |
| 10 | PRICING_PROCEDURE_FETCH | Fetch the pricing procedures |
| | | for a sales area from ERP |
| | | processing module |
| 11 | SALES_AREA_FETCH | fetch all the sales areas for |
| | | ERP processing module |
| 12 | CONFIGURABLE_MATERIALS_UPDATE | Update/create/delete classes, |
| | | characteristics, characteristic |
| | | values for configurable |
| | | materials |
| 13 | MATERIAL_FOR_DELETION | Fetches materials that are |
| | | marked for deletion for ERP |
| | | processing module |
| 14 | CONFIG_MATERIAL_MOD_BTWN_DATES | Fetches configurable |
| | | materials that were modified |
| | | between dates |

In performing the tasks from Table 3, example tasks illustrate operation of system 100. Consider an example to fetch base information for materials from ERP processing module 111. An input XML file is used. Different criteria may be specified to retrieve the basic information for the configurable materials. The following examples extract basic information for all the configurable materials in the system.

```
<?xml version=“1.0” encoding=“UTF-8”?>
<MaterialInput>
    <materialNumber/>
    <plant>100</plant>
    <materialType>KMAT</materialType>
    <createdFrom/>
    <createdTo/>
</Material>
```

System 100 may extract one or more configurable materials from ERP processing system at a time. It will export the data for the materials to a file(s) specified in TaskList.xml.

```
<?xml version=“1.0” encoding=“UTF-8”?>
<ConfigurationInput>
    <configurableMaterials>ACCLV1200</configurableMaterials>
    <configurableMaterials>HAMMER</configurableMaterials>
    <configurableMaterials>FPBIKE</configurableMaterials>
    <configurableMaterials>FP_COMPANYNETWORK</
    configurableMaterials>
</ConfigurationInput>
```

In order to appreciate the contents of the metadata database as it is utilized to create entity objects for transmitting data between integrated selling application module 102 and ERP processing module 111 various components of the data mapping are needed. These components include classes and attributes, variant tables, dependencies, procedures and actions, constraints, and selected conditions. Each of these components used in making transformations in one exemplary embodiment. These components that are stored in metadata database 302 are discussed below in detail. Various products, rules and dependencies are shown for illustrative purposes only and are not intended to be exhaustive. One skilled in the art will recognize that many other example transformations are possible without departing from the present invention.

First consider classes and attributes. The following tables illustrate how data mapping is done between selling application module 102 and ERP Variant Configuration data from metadata database 302 in an exemplary embodiment. All the attributes from ERP processing module 111 are captured in the integrated selling application module 102 so that the data can be mapped back to the ERP processing module 111 for future release. All classes with a class name starting with VC are used to keep ERP data only.

| ERP | Selling app (behavior) | Comments |
|---|---|---|
| Description | LangDescription (Indexed) | All supported languages in your ERP |
| | | system must be entered in editor.ini, for |
| | | example, ERPLanguages = EN, |
| | | DE, FR, ES EN, DE, FR and ES are the |
| | | language codes for all languages |
| | | supported in a specific system. |
| Configurable Class | VCClasses (none) | One VCClass instance for a |
| | | Configurable Class. |
| Configurable Material | Product (None) | One Product instance for a Configurable |
| | | Material. |
| Profile | VCProfile (None) | One VCProfile instance for an ERP |
| | | PROCESSING SYSTEM profile. |
| DependencyNet | VCDependencyNet(None) | Each DependencyNet can have 0 to N |
| | | Global Dependencies. |
| Constraint | VCGlobalDependency | A constraint can consist of one or more |
| | (None) | than one global dependencies. |
| Characteristics | OptionGroups (Category) | One OptionGroups instance for a |
| | | characteristic. Each characteristic itself is |
| | | an option child class. |
| Characteristic Values | Options (Min/Max) - | Each characteristic value is created as |
| | parent | an instance in an option child class that |
| | CharacteristicName | happens to be the characteristic that the |
| | (Min/Max) - child class | characteristic value belongs to. |
| Document for each | VCDocument (None) | A document instance is only created |
| item in VC | | when at least one of its fields has valid |
| | | value. |
| BasicData for each | VCBasicData (None) | One VCBasicData instance for a |
| item in VC | | BasicData. |
| StandData for | VCStandData (None) | One VCStandData instance for a |
| each item in VC | | StandData. |
| AdditionalData for | VCAdditionalData (None) | One VCAdditionalData instance for an |
| each item in VC | | AdditionalData |
| Global Dependencies | VCGlobalDependency | One VCGlobal Dependency instance for |
| | (None) | a global dependency. |
| Local Dependencies | VCLocalDependency | One VCLocalDependency instance for a |
| | (None) | local dependency. |
| Variant Table | VCVariantTable (None) | One VCVariantTable instance for a |
| | | variant table. |
| Characteristic in | VTCharacteristic (None) | ERPID is the name of the characteristics. |
| Variant Table | | |
| Assignment | VTAssignmentAlternatives | ValueAssignmentNumber is the lineNo. |
| Alternatives in | (None) | |
| Variant Table | | |
| Table Entry (Data) in | Options (Min/Max) - | The data in Variant Table will be created |
| Variant Table | parent | as instances in the child options class if |
| | CharacteristicName | the data don't exist in the characteristics |
| | (Min/Max) - child | yet. |
| Material | VCMaterial(None) | One VCMaterial for a material that can |
| | | be configurable or non-configurable. |
| Configurable Material | MainGroup (Category) | This class keeps track of all the |
| | | characteristics and allowed values |
| | | assigned to a material. |
| Configurable Class | Groups (Category) | This class keeps track of all the |
| | | characteristics and allowed values |
| | | assigned to a class. |
| | RootProductTree (None) | PDM Root Product tree. |
| | ProductGroup (None) | This class keeps track of all the |
| | | configurable and non-configurable |
| | | materials that have been imported to the |
| | | database. |
| | StdIncludes (Includes) | Each configurable material has one |
| | | StdIncludes instance attached to it. This |
| | | instance keeps the default allowed |
| | | values for this material. |
| | CondIncludes (Conditional | The instances are associated with |
| | Includes) | Spreadsheet to keep track of the data in |
| | | variant tables. |
| | IdxData (None) | Entries are used by selling application |
| | | module. |
| | Calculations (None) | Entries are used by selling application |
| | | module. |
| | GenCodes (Generated | Entries are used by selling application |
| | Code) | module. |
| | Price (Indexed and Price) | It has as many Price attributes as shown |
| | | in the XML file. All supported Prices must |
| | | be entered in editor.ini. |

Next consider variant tables. Variant tables may include single characteristic variant tables, actions and procedures, constraints and preconditions. ERP Variant Tables are used to store combinations of values for different characteristics—for example, you can only have a gray car interior if the car's paintwork is blue. The following variant table has two characteristics in the table structure. Characteristic HAMMER_SIZE is defined as a key field in the value assignment alternative.

| Characteristic | Key Field |
|---|---|
| HAMMER_SIZE | X |
| XHAMMER_SIZE | |

The table entries have the following combinations of values.

| HAMMER_SIZE | XHAMMER_SIZE |
|---|---|
| 4.00 in | HAMMERSIZE |
| 5.00 in | HAMMERSIZE1 |
| 6.00 in | HAMMERSIZE2 |
| 8.00 in | HAMMERSIZE3 |

In an ERP Action dependency, table THAMMER_SIZE is used to infer the data.

TABLE THAMMER_SIZE

(HAMMER_SIZE = HAMMER_SIZE ,
xHAMMER_SIZE = $self.xHAMMER_SIZE)

Assigning a value to characteristic HAMMER_SIZE infers values XHAMMER_SIZE.

For a variant table that has only one characteristic and is assigned to a characteristic or a characteristic value, the Plug-in will import it as a rule. For a variant table that has more than one characteristic, the Plug-in will create a Spreadsheet based on how the variant table is used.

All Spreadsheets in the same database are kept in the same tree node (ERPSpreadsheets). This tree node name and all spreadsheet names are kept in the mapping file. When a Variant Table is imported, the data will be removed and re-created if it was already imported.

There are three types of Spreadsheets for variant tables. The first is for a variant table used in Actions or Procedures. The second is for a variant table used in Constraints. The third is for a variant table used in Pre-conditions.

The next type of variant tables are variant tables with a single characteristic.

The following variable table tableOptionB has only one Characteristic called OptionB and there are two characteristic values in the variant table.

OptionB
B3
B4

A local dependency is referred to tableOptionB and assigned to characteristic OptionC.

table tableOptionB
(OptionB = OptionB)

After importing, it will be converted to the following relationship:

OptionC IsCOMPATIBLE WHEN MAP Local B3 OR B4

The next type of variant tables are variant tables with a single characteristic. A spreadsheet that is a variant table for actions and procedures contains option groups that are seen as source and as target option groups. The spreadsheet contains a unit for each option group. Cells in source option group units contain options that may be selected. Cell in target option group units contain options that will be included.

This spreadsheet generates data so that when all of the source options in a row are selected, the target options in that row will be included. Each target unit uses a class that defines how the options are included.

OptionB
B3
B4

In the spreadsheet above, BIKEMODEL is a source option group and BIKECOLOR is a target option group. BIKEMODEL contains the options MOUNTAIN, RACING_{—}1, STANDARD_{—}1, TANDEM, and TODDLER. BIKECOLOR contains the options BG, BK, FL, KR, and MG. From the first data row, selecting MOUNTAIN will cause BG to be included.

The next type of variant tables are actions and procedures. A spreadsheet that is a variant table for constraints contains options from two or more option groups. Each option group has its own unit and there is an extra unit that contains generated conditional includes that are used by the processed data.

This spreadsheet generates data so that when any option in a row is selected, all of other options in the row are included. The ConfigWorkArea unit uses a class that defines how the options are included.

| BIKEMODEL | BIKECOLOR |
|---|---|
| MOUNTAIN | BG |
| RACING_1 | BK |
| STANDARD_1 | FL |
| TANDEM | KR |
| TODDLER | MG |

In the spreadsheet above, TABLECHAR1 and TABLECHAR2 are option groups. TABLECHAR1 contains the options T11, T12, T13, and T14. TABLECHAR2 contains the options T21, T22, T23, and T24. From the first data row, selecting T11 will cause T21 to be included and selecting T21 will cause T11 to be included.

The next type of variant tables are constraints. A spreadsheet that is a variant table for constraints contains options from two or more option groups. Each option group has its own unit and there is an extra unit that contains generated conditional includes that are used by the processed data.

This spreadsheet generates data so that when any option in a row is selected, all of other options in the row are included. The ConfigWorkArea unit uses a class that defines how the options are included.

| TABLECHAR1 | TABLECHAR2 | ConfigWorkArea |
|---|---|---|
| T11 | T21 | CondInc1938 1 |
| T12 | T22 | CondInc1940 1 |
| T13 | T23 | CondInc1942 1 |
| T14 | T24 | CondInc1944 1 |

In the spreadsheet above, TABLECHAR1 and TABLECHAR2 are option groups. TABLECHAR1 contains the options T11, T12, T13, and T14. TABLECHAR2 contains the options T21, T22, T23, and T24. From the first data row, selecting T11 will cause T21 to be included and selecting T21 will cause T11 to be included.

The next type of variant tables are pre-conditions. A spreadsheet that is a variant table for preconditions contains option groups that are seen as source and as target option groups. The spreadsheet contains a unit for each option group. Cells in source option group units contain options that may be selected. Cell in target option group units contain options that will become available.

This spreadsheet generates data so that when all of the source options in a row are selected, the target options in that row will become available.

| BIKEMODEL | EXTRAS |
|---|---|
| MOUNTAIN | BASKET |
| RACING_1 | LUGGAGE_RACK |
| STANDARD_1 | MUDGUARD |
| TANDEM | STAND |

In the spreadsheet above, BIKEMODEL is a source option group and EXTRAS is a target option group. BIKEMODEL contains the options MOUNTAIN, RACING_{—}1, STANDARD_{—}1, and TANDEM. EXTRAS contains the options BASKET, LUGGAGE_RACK, MUDGAURD, and STAND. From the first data row, selecting MOUNTAIN will cause BASKET to become available.

Dependencies between field values are also included within the metadata database in which mapping must occur. The following table describes various dependencies supported in the exemplary embodiment.

| ERP PROCESSING | | |
|---|---|---|
| SYSTEM | | |
| Object/Condition | Condition | Object Created Inside the PDM |
| Dependency: | All | 1+ Compatibility grammar. |
| PreCondition | | |
| Dependency: | Uses Specified keyword | 1+ Generated code (for each specified |
| PreCondition | | command). |
| | | 1+ Compatibility grammar. |
| Dependency: | Uses Table keyword | 1 Spreadsheet or a rule if a single |
| Procedure | | characteristic used in the table. |
| Dependency: | Follows this format: | 1+ Conditional Include grammar with a |
| Procedure | <Char> <Op> <value> if | rule. |
| | (precondition) | |
| | where <Value> is a number or | |
| | text value that refers to an | |
| | allowed value. | |
| Dependency: | Follows this format: | 1+ Value option with a rule if a |
| Procedure | <Char> <Op> <calc> if | precondition exists. Attaches it to the |
| | (precondition) | category that it before the operator. |
| | where <calc> is a calculation | |
| | that resolves to an inferred | |
| | value. | |
| Dependency: | | 1+ Pricing rule. |
| Procedure: | | |
| Dependency: | It doesn't fit any of the other | It is converted into a procedure and |
| Constraint: | constraint formats below | could produce anything that a procedure |
| | | produces. |
| Dependency: | Takes the format: | 1+ GlobalConstraint with the items listed |
| Constraint | <characteristic> IN (...) if | in the “IN” statement AND'ed with the |
| | (precondition) | precondition. |
| Dependency: | <Characteristic> = | Not converted. |
| Constraint | <Characteristic> in the | |
| | restriction section | |
| Dependency: | Inconsistent condition | 1+ Message Rule. |
| Constraint | | |
| Dependency: | Uses Part_of or SubPart_of | Not converted. |
| Constraint | keywords | |
| Dependency: | All | 1 Compatibility grammar. |
| Selection Condition | | 1 Include grammar. |

When looking at dependencies within ERP processing module 111, following text will break down the dependency to explain what this dependency means inside integrated selling application module 102.

“HAMMER₁₃ SIZE EQ 5.00”, refers to a category under the product HAMMER whose ERPID attribute equals “HAMMER_SIZE”. When it says EQ or (=), it means equal to an option inside that category whose ERPID value is equal to 5.00. So, in the PDM, this part of the rule can be written as “(HAMMER AND 5_{—}00_)”.

HAMMER limits the rule so that it is only applied to the attached product, and 5_{—}00_is the option whose ERPID value is “5.00”.

In the next part, you can see that everything is the same except for the operator. Instead of an equal sign, we have a greater than or equal to sign. As a result, we would look at the category under the product whose ERPID value was equal to “HAMMER_SIZE”, and find all the options whose ERPID value is >=6.00. That part of the rule might be converted to “(HAMMER AND (6_{—}00_OR 7_{—}00_OR 8_{—}00_)”. If we combine the parts together by the listed OR, the rule for IR350R would be:

(( HAMMER AND 5_00_{——}) OR ( HAMMER AND
(6_00_{——}OR 7_00_{——}OR 8_00_{——}
))

Consider the following example illustrating dependencies:
Referenced by: IR350R
SrcText: HAMMER_SIZE EQ 5.00 OR HAMMER_SIZE >=6.00
ProductList: HAMMER

The VCLocalDependency and VCGlobalDependency classes hold the raw information about a dependency along with some additional information that is used to help convert dependencies later. There are three additional attributes added to each dependency record. They are called the “ProductList”, “ReferencedBy”, and “is Converted” attributes. The “ProductList” attribute tells what products use the dependency. The “ReferencedBy” attribute is used to tell what “allowed Values” reference the dependency. Finally, the “is Converted” attribute is used for the end-user to determine if the dependency was successfully converted. If it is checked, it is converted.

In the above example, three added fields are used. These are IsConverted, ProductList and ReferencedBy. IsConverted is used to tell whether it was converted successfully by the rule converter. If this field is checked after importing the XML file, the program was able to convert it successfully. If it is not checked, the program had problems converting it. ProductList tells what product or products use this dependency. It is used to make the rules apply only to the products listed. ReferencedBy is used to tell where some of the rules or includes are to be applied.

Next, Preconditions are described. Preconditions in ERP processing module 111 are very similar to configuration rules inside the integrated selling module 102. For each Precondition, a grammar rule is created.

For example, a list of “ReferencedBy” instances are used to build the first part of the grammar (“IR350A IsCompatible WHEN MAP Local”) to bui9ld the rule. This attaches the rule to the instances that make reference to the dependency.

Next, each token inside the “SrcText” field are parsed. The pattern “WORD” “OPERATOR” “WORD” is specifically detected. In the first case, “HAMMER_SIZE EQ 5.00”, a category inside the product that had an ERPID value of “HAMMER_SIZE” is searched. Its options are searched to see if it had an option whose ERPID value matched “5.00”. Once this option is found, it is added to the rule. To make sure this rule was valid for this particular product, the product is also added to the rule.

Consider the following example illustrating a precondition:
Referenced by: IR350R
SrcText: HAMMER_SIZE EQ 5.00 OR HAMMER_SIZE >=6.00
ProductList: HAMMER

The dependency above will produce the following grammar:
IR350R IsCompatible WHEN MAP Local (HAMMER AND (5_{—}00_OR 6_{—}00_))

The next item detected are “IN” keywords. Whenever you have an IN statement, it is saying to look in the product for a category, specified before the IN statement, whose ERPID value is equal to “PENETRATION_RATE”. Then, look inside the parentheses and try to find options inside that category whose ERPID value matches the items listed. Again, to limit the rule, we add the product to the rule.

Consider the following example illustrating an IN keyword:
Referenced by: IR350R
SrcText: PENETRATION_RATE IN (0,31, 0,54, 0,64)
ProductList: HAMMER

The use of the IN keyword above will produce the following grammar: IR350R IsCompatible WHEN MAP Local (HAMMER AND (0_{—}31_m_min OR 0_{—}54_m_min OR 0_{—}64_m_min)).

The next item detected are “Specified” keywords. In this example, the first part is converted the same as above. The SrcText for this example is different. The “HAMMER_SIZE SPECIFIED” or “SPECIFIED HAMMER_SIZE” will create a “Generated” code in the selling application module 102 that contains all of the options inside the hammer size category. After adding the generated code, it then adds the product that uses this dependency, to the rule along with the generated code.

Consider the following example illustrating an IN keyword:
Referenced by: IR350R
SrcText: HAMMER_SIZE SPECIFIED
ProductList: HAMMER

The dependency above will produce the following grammar:
IR350R IsCompatible WHEN MAP Local (HAMMER AND *HAMMER_SIZE_{—}1)

Procedures or Action dependencies can create several different types of objects inside the selling application module 102. Depending on the format of the SrcText, the program could convert a single dependency into several rules or include grammar rules, or value options. A first example illustrates how a dependency is converted into three different include grammar rules. A second example illustrates how the dependency is converted into a value option with a rule. In these examples, numbers can be formatted in a few different ways. When two numbers are separated by commas without a space, the number can really be treated as a decimal. For example, 0,31 is really 0.31. 0,31, 0,54, 0,64 can be treated as 0.31, 0.54, 0.64 since there is a space after the comma in 31, 54.

In the first example, three lines are present in the SrcText field. Each line will be converted into a separate conditional include grammar.

To convert the first line, the line is divided into parts.

<Category value><operator><value or calc>IF<pre-condition (rule)>$SELF.HAMMER_SIZE=4 IF PENETRATION_RATE IN (0,31, 0,54, 0,64),

Once the line is separated into parts, “<CategoryValue><Operator><Value>” part tells what item will be included if the pre-condition part is met. We then create a conditional is created that includes grammar that uses the pre-condition part as the rule for the conditional include. The pre-condition part is converted by doing the following:
Referenced by: HAMMER_{—}1
ProductList: HAMMER
SrcText:
$SELF.HAMMER_SIZE=4 IF PENETRATION_RATE IN (0,31, 0,54, 0,64),
$SELF.HAMMER_SIZE=5 IF PENETRATION_RATE IN (0,67, 0,80, 0,84),
$SELF.HAMMER_SIZE=6 IF PENETRATION_RATE IN (0,29, 0,32, 0,37).

The above source text will produce the following grammar:
ALWAYS INCLUDES NO-UNDO STRICT QUANTITY 1 4_{—}00_WHEN (HAMMER AND (0_{—}31_m_min OR 0_{—}54_m_min OR 0_{—}64_m_min))
ALWAYS INCLUDES NO-UNDO STRICT QUANTITY 1 5_{—}00_WHEN (HAMMER AND (0_{—}67_m_min OR 0_{—}80_m_min OR 0_{—}84_m_min))
ALWAYS INCLUDES NO-UNDO STRICT QUANTITY 1 6_{—}00_WHEN (HAMMER AND (0_{—}29_m_min OR 0_{—}32_m_min OR 0_{—}37_m_min))

In the second example, the SrcText is split into parts:
<CategoryValue><Operator><Value or Calc>IF<precondition>

We first try to find the Category that matches the ERPID value (BIT_WEAR) under the product HAMMER. We then check to see if we are dealing with a value or a calculation. If a calculation is entered, we make a check to see if the category is a “NO Entry” category. No entry categories have an attribute called NoEntry checked. If it is checked, we create a value option and attach it to the category. We then make the “default value” of the value option, the calculation listed in the dependency. If we had a precondition on this dependency, we would add it as a rule on the value option.

The calculation is converted to PDM syntax. When it comes to a “CategoryValue”, ERP PROCESSING SYSTEM refers to this as the “first Selected Item in that category”. As a result, Category values are replaced with the following syntax:
$SELF.LENGTH_WITHOUT_BIT
Replaced with
@AsDouble(‘HAMMER_LENGTH_WITHOUT_BIT.OptionList.ERPID’)
Referenced by: HAMMER_{—}1
ProductList: HAMMER
SrcText:
$SELF.BIT_WEAR=FLOOR(($SELF.LENGTH_WITHOUT_BIT*SIN(39))+
$SELF.PENETRATION_RATE+($SELF.HAMMER_SIZE/2.25))/365.

The above source text will produce the following grammar:

Value Option DefaultValue:

[@Floor((@AsDouble(‘HAMMER_LENGTH_WITHOUT_BIT.OptionList.ERPID’)* @Sin(39))+@AsDouble(‘HAMMER_PENETRATION_RATE.OptionList.ERPID’)+(@AsDouble(‘HAMMER_HAMMER_SIZE.OptionList.ERPID’)/2.25))/365]

Next consider constraints including inconsistent messages, table keywords, and restricted allowed values. Inconsistent messages are constraints that deliver a message when they are true. In integrated selling application module's case, these constraints are converted to RuleMessages.

In the example below, a constraint is broken into the four main parts (Objects, Condition, RESTRICTIONS, and INFERENCES). An inconsistent message may be identified as having a condition, and a restriction that is “false”.

```
Example:
ReferencedBy: C_SERVER_1
ProductList: FP_COMPANYNETWORK
SrcText:
    OBJECTS:
    Server is_a (300) FP_C_SERVER
    CONDITION:
    server.FP_C_OP_SYSTEM = ‘OS2’
    RESTRICTIONS: False
Output:
RuleMessage:
Description:
‘FP_C_SERVER_FP_C_OP_SYSTEM.DescriptionList’ + “ = ” +
‘“OS2’”
Constraint_: (FP_COMPANYNETWORK AND OS2)
```

If a constraint uses the Table keyword, the constraint is ignored. If the constraint uses the Part_of or Subpart_of keywords, the constraint is ignored.

If you have a constraint that takes the following form: <Category Value>=<Category Value>, The constraint is not converted.

```
Format:
    OBJECTS:
    PC is_a (300)PC
    RESTRICTIONS:
    PC.COLOR_1 = PC.COLOR_2
    INFERENCES: PC.COLOR_1
```

Other types of constraints follow closely the procedure format and are formatted like procedures.

Finally consider selected conditions. Selection conditions are used to do two things. It is used to tell when to “show” hidden characteristics and when to enforce selections for these characteristics. When a selection condition is evaluated, it is converted into two parts. There will be one compatibility grammar that is used to set the visibility of the category (characteristic), and one include grammar that force any one item in that category to be selected at any given time while it is compatible.

For example:
Selection Condition:
SrcText: BIKEMODEL eq ‘Tandem’
ProductList: BIKE
RefBy: TANDEM_SADDLE_1
Output:
Compatible grammar:
TANDEM_SADDLE_1 IsCompatible WHEN MAP Local TANDEM
Include Grammar:
TANDEM Includes ONLYONE FORCED QUANTITY 1 CLOTH,
LEATHER, WOOL

In this example, to convert the dependency, the token BIKEMODEL is considered. BIKEMODEL in this example refers to a Characteristic or category under the product BIKE. The option whose ERPID value matches “Tandem” is found. A compatibility grammar rule that limits the categories visibility TANDEM_SADDLE_{—}1 comes from the refBy attribute. TANDEM comes from the name of the option whose ERPID value matches “Tandem”. We used this information to build “TANDEM_SADDLE_{—}1 IsCompatible WHEN MAP Local TANDEM”. Next, an include grammar is built that forces a selection in the category “TANDEM_SADDLE_{—}1”. The options listed, “CLOTH”, “LEATHER”, “WOOL”, are items in “TANDEM_SADDLE_{—}1”.

Using all of these transformation procedures in an exemplary embodiment, data and corresponding product rules may be transformed from data used within integrated selling application module 102 into data supported within ERP processing module 111. This transformation occurs using a Java entity objects corresponding to the XML document associated with the data being transmitted between integrated selling application module 102 and ERP processing module 111.

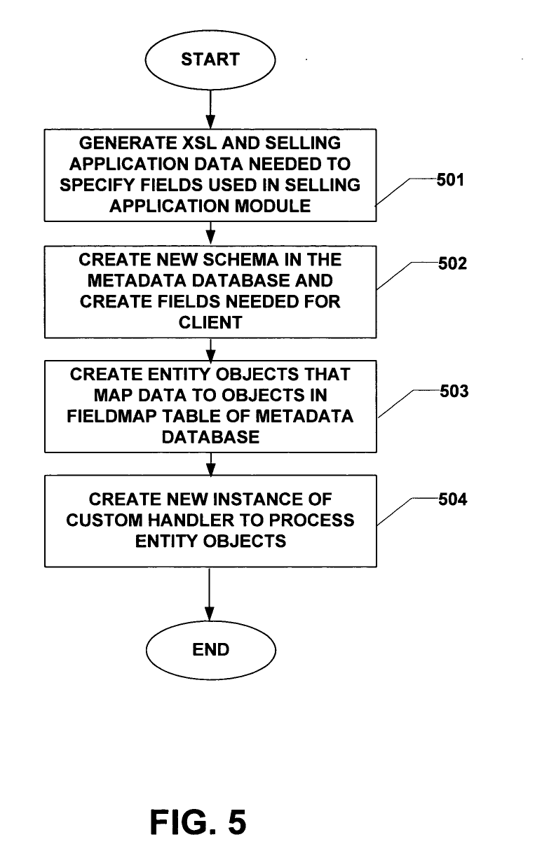

FIG. 5 is a flowchart describing a method integrating a custom connector module with system 100. As noted in reference to FIG. 1, a plurality of connector modules may be included within system 100 with the creation of necessary data within metadata database 322 that specifies the data transformation relationships needed. This processing begins with creation of XSL data (501) that defines the XML data transformation needed for data from integrated selling application 102 and a new application connected by a new connector module. This XSL data specifies the data fields used to reference the data of interest.

Once the XSL data is created, new XML schema data is created and stored within metadata database 322 to define the XML documents used in data transfer request tasks (502). These XML documents include fields within relational database tables of metadata database 322 used throughout the processing of the task requests.

After the XML data is generated, entity objects consisting of the Java classes used to processing the data being transferred is generated (503). These entity objects are maintained to create instances of class objects using metadata from metadata database 322 when data is transferred through a connector module. Once the entity objects are created, a new custom handler is created to control operation and initiation of instances of entity objects as needed when data is being transferred (504). With all of these components in place, data transfer requests may occur.

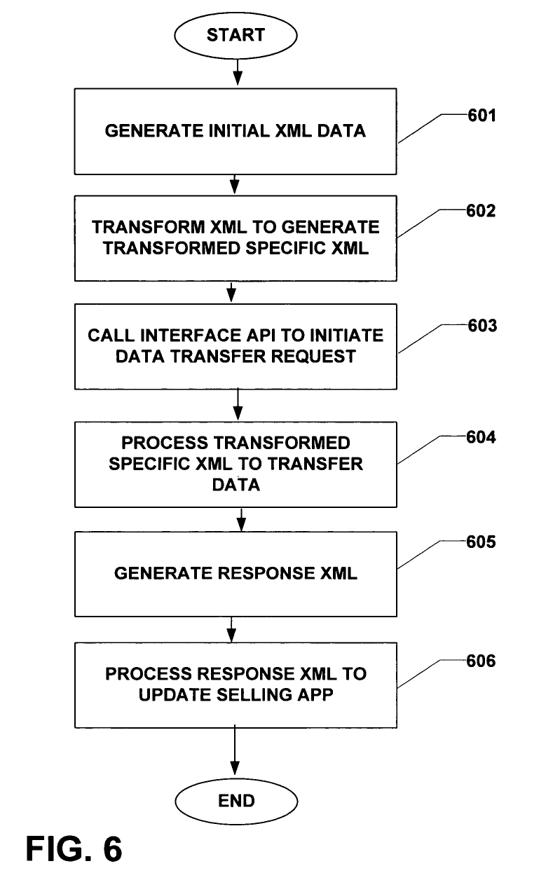

FIG. 6 is a flowchart illustrating an example submit order operation from a selling application module to an enterprise resource planning module according to the present invention. When integrated selling application module 102 desired to transmit data, such as an order for configured products prepared at the request of a particular customer, integrated selling application module 102 generates XML data 131 that contains relevant information regarding the configured product (601). The XML data 131 is stored within a domain XML file 122. The domain XML file typically references the sales data within data formats and field references used within integrated sales application module 102.

The domain XML file 133 is further processed into transformed XML data 132 (602) which is stored within a transformed specific XML file 123. This transformed XML data references the data in a common format understood within integrated interface module 103 and ERP connector module 110.

The transformed specific XML file contains order data for submission to the ERP processing module 111. Integrated selling application module 102 transmits the transformed specific XML data 123 to integrated interface module 103 in an call interface operation 133 (603). This call interface operation 133 creates a software class object within integrated interface module 103 that is then populated with sales data references within the transformed specific XML data 123. The created class object is then passed to ERP connector module 110. This module 110 that processes the create order operation specified in the class object to interact with ERP processing module 111 to insert product order information associated with a sale of configured products to a particular customer into the ERP processing module's data 112 for further use by the ERP processing module (604).

When the transformed specific XML data 123 is processed within ERP connector module 110, a response message indicating the status of the create sales operation (605). This messages is passed to integration interface module 103 and is used to generate response XML data 135 that is stored within response XML data file 121. The response XML data file 121 is returned to integrated sales application module 102 for further processing 136 as is needed to update the sales application module (606).

Various embodiments of the invention have been described.

These and other embodiments are within the scope of the following claims.

1. A method comprising:
generating a text data representation of a set of data being transferred from a first processing system to a second processing system;
processing the text data representation into a transformed text data representation referring to a common data format defined within a metadata database;
initiating a data transfer request between the first processing system and the second processing system; and
processing the transformed data representation using an entity object to transfer the set of data to the second processing system.

2. The method according to claim 1, wherein the method further comprises:
generating a response representation of data corresponding to output from the entity object processing of the transformed data representation; and
processing the response representation of data within the first processing system to update the first processing system regarding transfer of the set of data.

3. The method according to claim 2, wherein the text data representation, the transformed text data representation, and response representation of data comprise XML data files.

4. The method according to claim 1, wherein the entity objects comprise java class objects specified within metadata stored within the metadata database.

5. The method according to claim 4, wherein data stored within the metadata database is specified in an XML data format.

6. The method according to claim 1, wherein the first processing system comprises an integrated selling application module for specifying configurable products for sale to customers.

7. The method according to claim 1, wherein the second processing system comprises an enterprise resource planning module.

8. A computer-readable medium comprising instructions for causing a programmable processor to:
generate a text data representation being transferred from a first processing system to a second processing system;
process the text data representation into a transformed text data representation referring to a common data format defined within a metadata database;
initiate a data transfer request;
process the transformed data representation using an entity object to transfer the set of data to the second processing system;
generate a response representation of data corresponding to output from the entity object processing of the transformed data representation; and
process the response representation of data within the first processing system to update the first processing system regarding transfer of the set of data.

9. The computer-readable medium according to claim 8, wherein the text data representation, the transformed text data representation, and response representation of data comprise XML data files.

10. The computer-readable medium according to claim 8, wherein the entity objects comprise java class objects specified within metadata stored within the metadata database.

11. The computer-readable medium according to claim 10, wherein data stored within the metadata database is specified in an XML data format.

12. The computer-readable medium according to claim 8, wherein
the first processing system comprises an integrated selling application module for specifying configurable products for sale to customers; and
the second processing system comprises an enterprise resource planning module.

13. A method comprising:
generating XSL data associated with data fields of a selling application module used to transfer a set of data from the selling application module to an enterprise resource planning module;
creating new schema data files within a metadata database specifying one or more sets of data to be transferred between the selling application module and the enterprise resource planning module;
creating a plurality of entity objects specified with metadata stored within the metadata database to map data within the plurality of entity objects to data fields in the metadata database; and
creating an instance of a entity object handler to initiate creation of instances of one of the plurality of entity objects when the set of data is transferred between the selling application module and the enterprise resource planning module.
